(19) United States
(12) Patent Application Publication
(10) Pub. No.: US 2014/0317339 A1
(43) Pub. Date: Oct. 23, 2014

(54) DATA ACCESS SYSTEM, DATA ACCESSING DEVICE, AND DATA ACCESSING CONTROLLER

(71) Applicant: GENESYS LOGIC, INC., NEW TAIPEI CITY (TW)

(72) Inventor: Yu-Jen Hsu, Taipei City (TW)

(73) Assignee: GENESYS LOGIC, INC., NEW TAIPEI CITY (TW)

(21) Appl. No.: 14/231,832

(22) Filed: Apr. 1, 2014

(30) Foreign Application Priority Data
Apr. 19, 2013 (TW) 102 114 043

(51) Int. Cl. G06F 3/06

(52) U.S. Cl. CPC G06F 3/0658; G06F 3/0604; G06F 3/0683
USPC 711/103; 711/150

(57) ABSTRACT

A data access system, device and controller are provided. The data access system includes a plurality of storage units and first controllers, a second controller, and a host. The first controller is utilized to parallel access the storage units, and each first controller includes a plurality of first storage unit controllers, a buffer and a multiplexer. The first storage unit controllers are coupled one-to-one with the storage units. The multiplexer is coupled to the first storage unit controllers and the buffer. The second controller is coupled to the first controllers. The second controller includes a plurality of second storage unit controllers which are coupled one-to-one with the first controllers. The host is coupled to the second controller, and accesses the storage units through the second controller and the first controllers.

### CROSS REFERENCE

This application claims priority under 35 U.S.C. §119 to China Patent Application Serial Number 102114043, filed on Apr. 19, 2013, which is herein incorporated by reference.

### TECHNICAL FIELD

The present disclosure relates to a data access system, and especially to a data access system, a data access device and a data access controller used for a solid-state drive/disk.

### BACKGROUND

In recent years, a storage device which employs a NAND flash memory is tending to replace a conventional storage device with a hard disk. The storage device employing the NAND flash memory is now called solid-state drive/disk (SSD). A configuration of the SSD includes the flash memory, which is adopted to replace the disk of the conventional hard disk, combining with a control chip and a conventional hard drive interface for simulating as a hard drive. The NAND flash memory has no inherent mechanical latency of the hard drive, and a duty cycle thereof can be shortened, so its power consumption and shocks in the operation can be reduced. Therefore, SSD has not only commonality of the conventional hard drive, but also has advantages of high search efficiency, silent, low-temperature and so on of the memory.

Because portable consuming electronics such as smart phones or tablets are so popular that the memory industry also has a significant impact. The direction of development of the memory had changed into an embedded memory from an external memory card in past. One of the most popular memory solutions for the smart phones is an Embedded Multi-Media Card (eMMC). The so-called eMMC is a chip in which the NAND flash memory and a control chip are packaged by a multi-chip package (MCP) process, thereby simplifying the design processes of mobile phone manufacturers and reducing the area of components. With the increasing popularity of the eMMC, the design scheme of a storage unit which the eMMC is used as the solid-state drive had been proposed. Referring to FIG. 1, FIG. 1 depicts a block diagram illustrating a conventional solid-state drive system by adopting the eMMC. The conventional solid-state drive system 10 includes a serial advanced technology attachment (SATA) to eMMC controller 20 and a plurality of eMMC devices 30. The SATA to eMMC controller 20 includes a SATA host interface 22 and a plurality of eMMC interfaces 24 (or eMMC host controller). The SATA host interface 22 is utilized to interface a SATA host controller 42 of a host 40, and the eMMC interfaces 24 are utilized to connect with the plurality of eMMC devices 30.

However, in the present standard specification for the eMMC, one eMMC interface 24 can be connected only to one eMMC device 30. If it needs more capacity, the more eMMC devices 30 are required to couple thereto. For example, if the capacity of eight eMMC devices 30 is desired, eight corresponding eMMC interfaces 24 need to respectively couple thereto. Then the conventional eMMC host controller (i.e. eMMC interface 24) usually has 10 to 15 pins. If so many eMMC interfaces 24 are disposed, there are a large number of the pins, which occupy too many pins of the SATA to eMMC controller 20 realized in a system-on-chip (SoC). Moreover, the one-to-one connection between the plurality of eMMC interfaces 24 and eMMC devices 30 also hinders a parallelism of data processing, such that data access rate of the eMMC-based solid-state drive cannot be increased.

### SUMMARY

The present disclosure provides a data access system, which has multiple or one first controller to be utilized as a medium for coupling to multiple storage units, thereby solving the problem of the large number of the pins caused from the one-to-one connection between the plurality of eMMC interfaces and eMMC devices and the poor data access rate.

The present disclosure also provides a data access device, which has one first controller to be utilized as the medium for coupling to the multiple storage units, thereby solving the problem of the large number of the pins caused from the one-to-one connection between the plurality of eMMC interfaces and eMMC devices and the poor data access rate.

The present disclosure further provides a data access controller, which can be utilized as the medium for the conventional eMMC host controller coupling to the multiple storage units, thereby solving the problem of the one-to-one connection of the eMMC.

To achieve the foregoing, according to an aspect of the present disclosure, the present disclosure provides a data access system, which includes a plurality of storage units, a plurality of first controllers, a second controller and a host. The first controllers are utilized to parallel access the storage units, and each of the first controllers includes a plurality of first storage unit controllers, a buffer and a multiplexer. The first storage unit controllers are coupled one-to-one with the storage units. The multiplexer is coupled to the first storage unit controllers and the buffer. The second controller is coupled to the first controllers. The second controller includes a plurality of second storage unit controllers which are coupled one-to-one with the first controllers. The host is coupled to the second controller, and the host accesses the storage units through the second controller and the first controllers.

In one embodiment, each of the second storage unit controllers accesses at least two storage units of the storage units through a corresponding controller of the first controllers. Moreover, the corresponding controller accesses the at least two storage units in an interleaved manner.

In the embodiment, each of the storage units has a read/write unit, and a capacity of the buffer is equal to an integer multiple of that of the read/write unit.

In one embodiment, the storage units are a plurality of embedded multi-media card (eMMC) devices. More specifically, each of the second storage unit controllers is an eMMC host controller.

In one embodiment, the second controller further includes a storage unit selector for selecting one of the at least two storage units to be accessed.

In another embodiment, each of the first controllers further includes a memory unit, at which a lookup table is stored.

In one embodiment, the second controller further includes a processor and a data interface controller. The processor is coupled to the second storage unit controllers. The data interface controller is coupled between the processor and the host. In addition, the data interface controller is a serial data interface controller, which is one of SATA, USB, eSATA, PCI-e, and IEEE1394 controller.

The present disclosure further provides a data access system, which includes a plurality of storage units, a first controller, a second controller and a host. The first controller is utilized to parallel access the storage units, and the first controller includes a plurality of first storage unit controllers, a buffer and a multiplexer. The first storage unit controllers are coupled one-to-one with the storage units. The multiplexer is coupled to the first storage unit controllers and the buffer. The second controller is coupled to the first controller. The second controller includes a second storage unit controller, which is coupled to the first controller. The host is coupled to the second controller, and the host accesses the storage units through the second controller and the first controller.

In one embodiment, the storage units are a plurality of embedded multi-media card (eMMC) devices. More specifically, the second storage unit controller is an eMMC host controller.

In one embodiment, the second controller further comprises a storage unit selector for selecting one of the at least two storage units to be accessed.

In another embodiment, each of the first controllers further includes a memory unit, at which a lookup table is stored.

The present disclosure further provides a data access device, which includes a plurality of storage units, a first controller and a second controller. The first controller is utilized to parallel access the storage units. The first controller includes a plurality of first storage unit controllers, a buffer and a multiplexer. The first storage unit controllers are coupled one-to-one with the storage units. The multiplexer is coupled to the first storage unit controllers and the buffer. The second controller is coupled to the first controller. The second controller includes a second storage unit controller, a processor and a data interface controller. The second storage unit controller is coupled to the first controller. The processor is coupled to the second storage unit controller. The data interface controller is coupled to the processor.

In one embodiment, each of the storage units is an embedded memory. More specifically, the embedded memory is an eMMC and the second storage unit controller is an eMMC host controller.

In one embodiment, the second controller further comprises a storage unit selector for selecting one of the storage units to be accessed.

In another embodiment, each of the first controllers further comprises a memory unit, at which a lookup table is stored.

The present disclosure further provides a data access controller, which is utilized to parallel access a plurality of storage units and is coupled to another controller. The data access controller includes a plurality of second storage unit controllers, a buffer and a multiplexer. The first storage unit controllers are coupled one-to-one with the storage units. The multiplexer is coupled to the first storage unit controllers and the buffer.

In one embodiment, each of the storage units has a read/write unit, and a capacity of the buffer is equal to an integer multiple of that of the read/write unit.

Each of the first storage unit controllers is an eMMC host controller.

In one embodiment, the data access controller further includes a memory unit, at which a lookup table is stored.

In one embodiment, the another controller includes at least one second storage unit controller for coupling to the multiplexer, and a number of the at least one second storage unit is less than that of the storage units.

The data access system, device and controller of the present disclosure has a medium for the conventional eMMC host controller coupling to the multiple storage units, thereby solving the problem of the one-to-one connection of the eMMC.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

FIG. 1 depicts a block diagram illustrating a conventional solid-state drive system by adopting the eMMC;

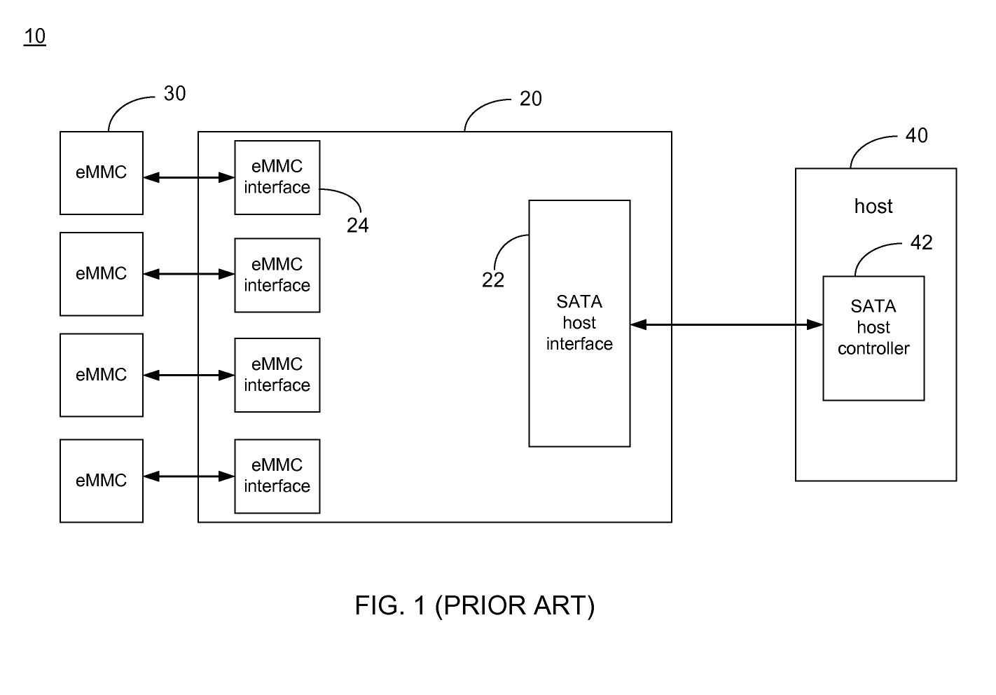

FIG. 2 depicts a functional block diagram illustrating a data access system according to a first embodiment of the present disclosure;

FIG. 3 depicts a detail block diagram illustrating a single first controller of FIG. 2;

FIG. 4 depicts a functional block diagram illustrating a data access system according to a second embodiment of the present disclosure;

FIG. 5 depicts a functional block diagram illustrating a data access device according to a third embodiment of the present disclosure; and

FIG. 6 depicts a functional block diagram illustrating a data access controller according to a fourth embodiment of the present disclosure.

### DETAILED DESCRIPTION

The present disclosure will now be described in detail with reference to exemplary embodiments thereof as illustrated in the accompanying drawings. The same reference numerals refer to the same parts or like parts throughout the various figures.

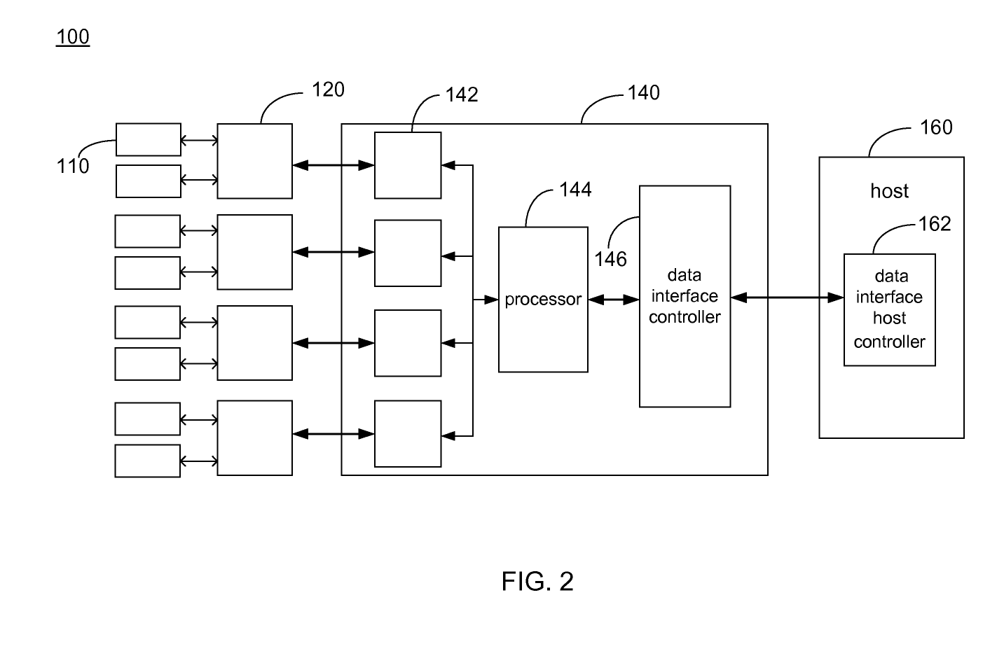

Referring to FIG. 2, FIG. 2 depicts a functional block diagram illustrating a data access system 100 according to a first embodiment of the present disclosure. The data access system 100 includes a plurality of storage units 110, a plurality of first controllers 120, a second controller 140 and a host 160. The first controllers herein are utilized to parallel access the storage units 110 respectively. In the first embodiment, each of the first controllers 120 is correspondingly coupled to at least two storage units 110. However, the present disclosure is not limited to accessing two storage units 110, accessing more than two storage units 110 is also within the spirit of the present disclosure.

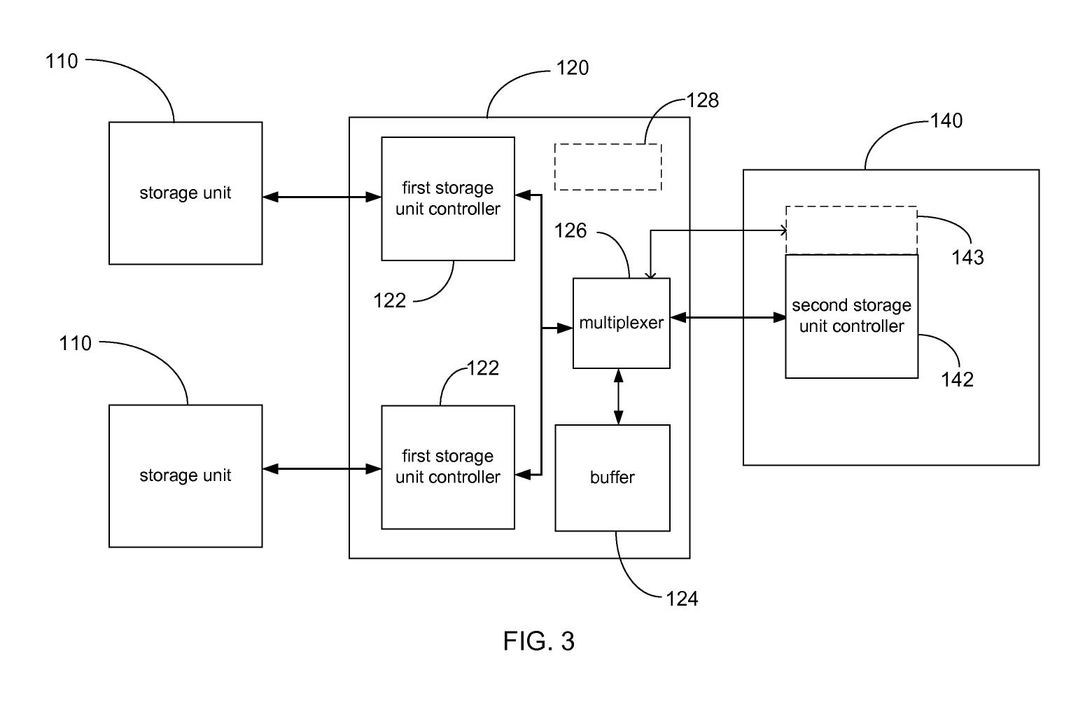

Referring to FIG. 2 and FIG. 3, FIG. 3 depicts a detail block diagram illustrating a single first controller 120 of FIG. 2. The first controller 120 includes a plurality of first storage unit controllers 122, a buffer 124 and a multiplexer 126. The first storage unit controllers 122 herein are coupled one-to-one with the storage units 110, and the multiplexer 126 is coupled to the first storage unit controllers 122 and the buffer 124.

Referring to FIG. 3 again, the second controller 140 is coupled to the first controllers 120. The second controller includes a plurality of second storage unit controllers 142, and the second storage unit controllers are coupled one-to-one with the first controllers 120. The second controller 140 further includes a processor 144 and a data interface controller 146. The processor 144 herein is coupled to the second storage unit controllers 142, and the data interface controller 146 is coupled between the processor 144 and the host 160. In the embodiment, the data interface controller 146 is a serial data interface controller, which is one of SATA, USB, eSATA, PCI-e, and IEEE1394 controller.

On the other hand, as shown in FIG. 2, the host 160 has a data interface host controller 162 for correspondingly coupling to the data interface controller 146, and the data interface host controller 162 is one of SATA, USB, eSATA, PCI-e, and IEEE1394 controller. By means of the above-mentioned data interface host controller 162 coupling to the data interface controller 146, the host 160 can access data from the storage units through the second controller 140 and the first controllers 120.

What follows is a detail of the operation with respect to the data access system 100. Referring to FIG. 3, FIG. 3 is the detail block diagram illustrating the single first controller 120 of FIG. 2. The first controller 120 includes a plurality of first storage unit controllers 122, a buffer 124 and a multiplexer 126. The first storage unit controllers 122 herein are coupled one-to-one with the storage units 110, and the multiplexer 126 is coupled to the first storage unit controllers 122 and the buffer 124. Further referring to FIG. 3, the second storage unit controller 142 of the second controller 140 accesses the at least two storage units 110 through the multiplexer 126 of the corresponding first controller 120.

In the embodiment, the storage units 110 are a plurality of embedded multi-media card (eMMC) devices, and each of the second storage unit controllers is an eMMC host controller 142. In the embodiment, the transmission of the second storage unit controller 142 and the storage units 110 is explained as, for example, a standard for the eMMC, but it is not limited to this. For example, the eMMC specification can be replaced by the standard for an embedded Secure Digital (eSD) card or for an embedded Compact Flash (eCF) card, as long as the interfaces used between the second storage unit controller 142 and the storage units 110 are the same.

What follows is the operation with respect to the first controller 120 of the first embodiment. As shown in FIG. 3, the first controller 120 accesses the at least two storage units 110 in an interleaved manner. Specifically, in the embodiment, the second controller 140 further includes a storage unit selector 143, and the storage unit selector 143 is disposed preferably in (but not limited to) the second storage unit controller 142. The storage unit selector 143 is utilized to select one of the at least two storage units 110 to perform the data access. More specifically, the storage unit selector 143 is capable of sending a control signal to the multiplexer 126, and the second storage unit controller 142 which is utilized as the eMMC host controller sends a standard eMMC command. The control signal is utilized to control the multiplexer 126 for assigning the standard eMMC command to which one of the first storage unit controllers 122, so as to access one of the storage units 110 implemented by the eMMC devices. It is worth mentioning that the second storage unit controller 142 utilized as the eMMC host controller has additional pins for providing the above-mentioned control signal in the embodiment.

It should be noted that the first storage unit controller 122 of the embodiment also can be a standard eMMC host controller for accessing a single storage unit 110 implemented by the eMMC device.

In another embodiment, the second storage unit controller 142 is a standard eMMC host controller without disposing the above-mentioned storage unit selector 143. More specifically, the second storage unit controller 142 can send the vendor commands to the first controller 120. Based on the control of the vendor commands, the one-to-many objective is achieved.

In another embodiment, the first controller 120 further includes a memory unit 128, at which a lookup table (LUT) is stored. Specifically, the two storage units 110 are simulated as a block device, such as the hard disk. Before accessing the two storage units 110, the lookup table includes the information of logical-physical address mapping, which is utilized to record the relationship of logical block addresses (LBA) converting into physical block addresses (PBA). The logical block addresses are the block addresses which a file system accesses the data; the physical block addresses are the block addresses to which the logical block addresses actually correspond in the storage units 110.

It is worth mentioning that the storage unit has a read/write unit, and a capacity of the buffer 124 within the first controller 120 is equal to an integer multiple of that of the read/write unit. The buffer 124 is utilized to temporarily store the read/write data from the two storage units 110, so as to increase the parallelism of data processing of the first controller 120.

It can be seen from FIG. 2 that the data access system 100 of the first embodiment employs a plurality of one-to-two first controllers 120 to utilize as media for coupling to the plurality of storage units 110, thereby solving the problem of the large number of the pins caused from the one-to-one connection between the plurality of eMMC interfaces and eMMC devices and the poor data access rate.

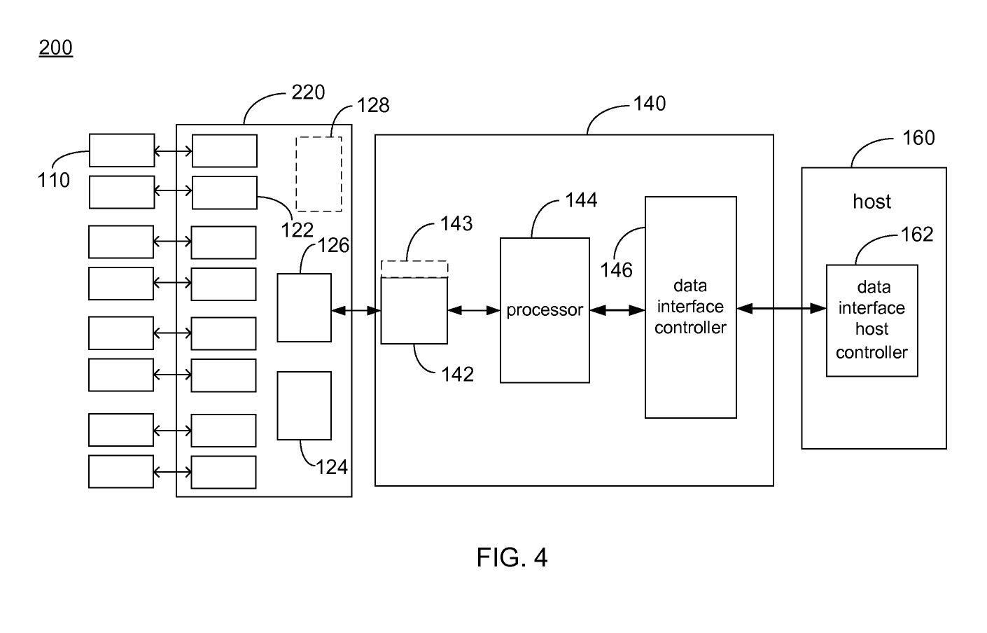

The data access system of a second embodiment of the present disclosure in the accompanying block diagram will be explained in the following. Referring to FIG. 4, FIG. 4 depicts a functional block diagram illustrating a data access system 200 according to a second embodiment of the present disclosure. The data access system 200 includes a plurality of storage units 110, a first controller 220, a second controller 140, and a host 160.

As shown in FIG. 4, the first controller 220 is utilized to parallel access the storage units 110. The first controller 220 includes a plurality of first storage unit controllers 122, a buffer 124 and a multiplexer 126. The first storage unit controllers 122 herein are coupled one-to-one with the storage units 110, and the multiplexer 126 is coupled to the first storage unit controllers 122 and the buffer 124 respectively.

The second controller 140 is coupled to the first controller 220, and includes a second storage unit controller 142, a processor 144, and a data interface controller 146. The second storage unit controller 142 herein is coupled between the multiplexer 126 of the first controller 220 and the processor 144. The processor 144 is coupled to the data interface controller 146, and the host 160 is coupled to the data interface controller 146 of the second controller 140, whereby the host 160 can access the storage units 110 through the second controller 140 and the first controller 220. One difference from the above-mentioned first embodiment is that the first controller 220 of the second embodiment is a one-to-eight controller, and each of the first controllers 120 of the first embodiment is a one-to-two controller.

Specifically, the storage units 110 are the plurality of embedded multi-media card (eMMC) devices, and the second storage unit controller 142 is one eMMC host controller. In the embodiment, the transmission between the second storage unit controller 142 and the storage units 110 is explained as, for example, the standard for the eMMC, but it is not limited to this.

What follows is the operation with respect to the second controller 220 of the first embodiment. As shown in FIG. 4, the first controller 220 accesses the storage units 110 in the interleaved manner. Specifically, in the embodiment, the second controller 140 further includes a storage unit selector 143, and the storage unit selector 143 is disposed preferably in (but not limited to) the second storage unit controller 142 for selectively access one of the storage units 110. Similarly, the storage unit selector 143 is capable of sending a control signal to the multiplexer 126, and the second storage unit controller 142 utilized as the eMMC host controller used to send a standard eMMC command. The control signal is utilized to control the multiplexer 126 for assigning the standard eMMC command to which one of the first storage unit controllers 122, so as to access one of the storage units 110 implemented by the eMMC devices.

In another embodiment, the second storage unit controller 142 is a standard eMMC host controller without disposing the above-mentioned storage unit selector 143. More specifically, the second storage unit controller 142 can send the vendor commands to the first controller 120. Based on the control of the vendor commands, the one-to-many objective is achieved.

In another embodiment, the first controller 120 further includes the memory unit 128, at which the lookup table (LUT) is stored. Specifically, the storage units 110 are simulated as the block device, such as the hard disk. Before accessing the storage units 110, the lookup table includes the information of logical-physical address mapping, which is utilized to record the relationship of the logical block addresses (LBA) converting into the physical block addresses (PBA). The logical block addresses are the block addresses which the file system accesses the data; the physical block addresses are the block addresses to which the logical block addresses actually correspond in the storage units 110.

It can be seen from the foregoing that the data access system 200 of the second embodiment has the one-to-eight first controller 220 being capable of utilizing as the medium for coupling to the multiple storage units 110, thereby solving the problem of the one-to-one connection.

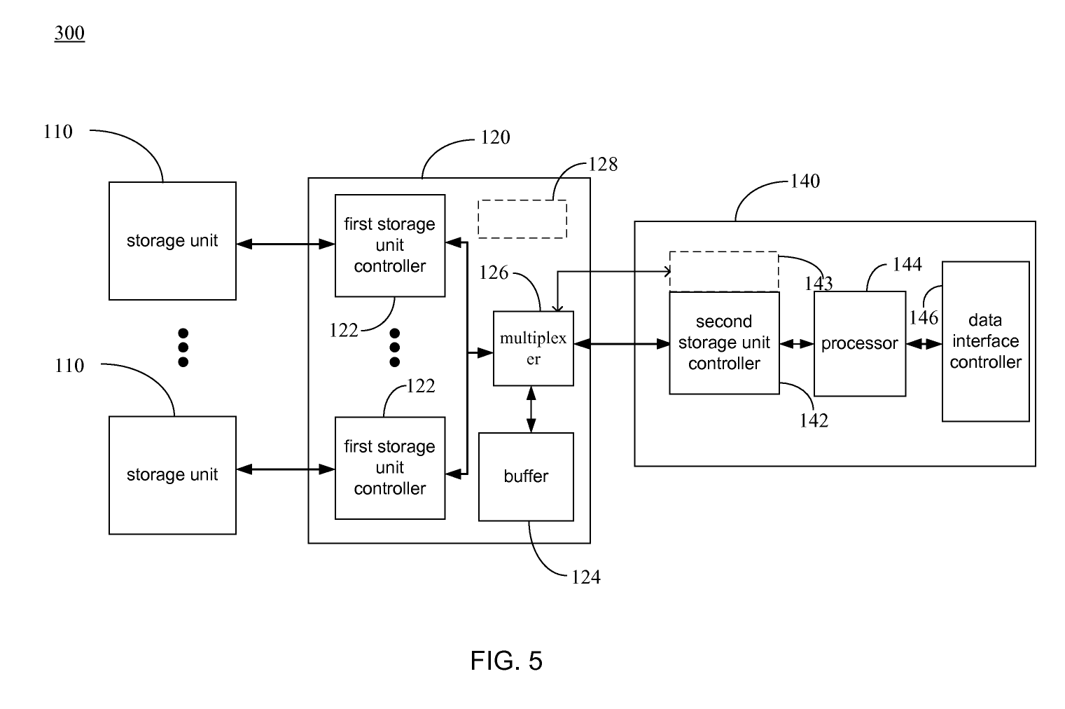

The data access device of a third embodiment of the present disclosure will be explained in the following. The data access device can be a solid-state drive preferably; however, the present disclosure is not limited to be implemented hereby. Referring to FIG. 5, FIG. 5 depicts a functional block diagram illustrating a data access device 300 according to an embodiment of the present disclosure. The data access device 300 includes a plurality of storage units 110, a first controller 120, and a second controller 140.

The first controller 120 is utilized to parallel access the storage units 110. The first controller 120 includes a plurality of first storage unit controllers 122, a buffer 124 and a multiplexer 126. The first storage unit controllers 122 are coupled one-to-one with the storage units 110. The multiplexer 126 is coupled to the first storage unit controllers 122 and the buffer 124. The second controller 140 is coupled to the first controller 220, and includes a second storage unit controller 142, a processor 144, and a data interface controller 146. The second storage unit controller 142 herein is respectively coupled between the multiplexer 126 of the first controller 220 and the processor 144. The processor 144 is coupled to the second storage unit controllers 142. The data interface controller 146 is coupled the processor 144, and the data interface controller 146 is utilized to couple to an external host.

Each of the storage units 110 is an embedded memory. In the embodiment, the embedded memory is the eMMC, and the second storage unit controller 142 is an eMMC host controller. In the embodiment, the transmission between the second storage unit controller 142 and the storage units 110 is explained as, for example, the standard for the eMMC, but it is not limited to this. For example, the eMMC specification can be replaced by the standard for the eSD card or for the (eCF) card, as long as the interfaces used between the second storage unit controller 142 and the storage units 110 are the same.

What follows is the operation with respect to the first controller 120 of the third embodiment. As shown in FIG. 5, the first controller 120 accesses the storage units 110 in the interleaved manner. In the embodiment, the second controller 140 further includes a storage unit selector 143, and the storage unit selector 143 is disposed preferably in (but not limited to) the second storage unit controller 142 for selectively access one of the storage units 110. More specifically, the storage unit selector 143 is capable of sending the control signal to the multiplexer 126, and the second storage unit controller 142 which is utilized as the eMMC host controller sends the standard eMMC command. The control signal is utilized to control the multiplexer 126 for assigning the standard eMMC command to which one of the first storage unit controllers 122, so as to access one of the storage units 110 implemented by the eMMC devices.

It should be noted that the first storage unit controller 122 of the embodiment also can be a standard eMMC host controller for accessing a single storage unit 110 implemented by the eMMC device.

In another embodiment, the second storage unit controller 142 is a standard eMMC host controller without disposing the above-mentioned storage unit selector 143. More specifically, the second storage unit controller 142 can send the custom vendor commands to the first controller 120. Based on the control of the vendor commands, the one-to-many objective is achieved.

In another embodiment, the first controller 120 further includes the memory unit 128, at which the lookup table (LUT) is stored. Specifically, the two storage units 110 are simulated as a block device, such as the hard disk. Before accessing the storage units 110, the lookup table includes the information of logical-physical address mapping, which is utilized to record the relationship of logical block addresses (LBA) converting into physical block addresses (PBA). The logical block addresses are the block addresses which a file system accesses the data; the physical block addresses are the block addresses to which the logical block addresses actually correspond in the storage units 110.

It can be seen from the foregoing that the data access device 300 of the embodiment has an one-to-many first controller 120 being capable of utilizing as the medium for coupling to the multiple storage units 110, thereby solving the problem of the one-to-one connection.

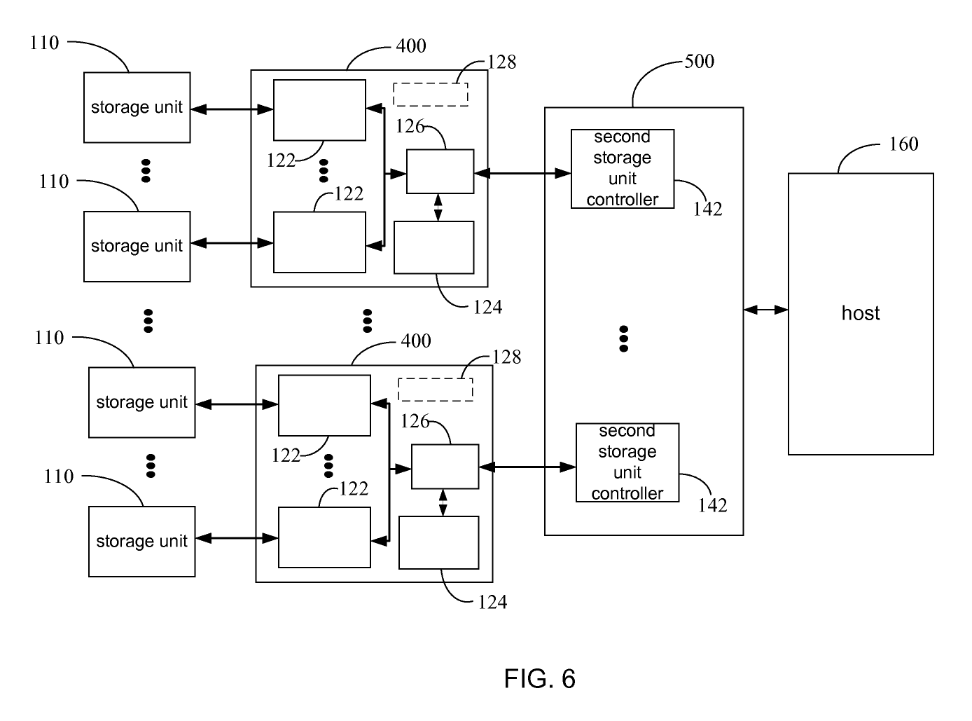

The data access controller of a fourth embodiment of the present disclosure will be explained in the following. Referring to FIG. 6, FIG. 6 depicts a functional block diagram illustrating data access controllers 400 according to a fourth embodiment of the present disclosure. Configuration of each of the data access controllers 400 is the same with the first controller of the previous embodiments. That is, each includes a plurality of first storage unit controllers 122, a buffer 124 and a multiplexer 126. The first storage unit controllers 122 herein are coupled one-to-one with the storage units 110. The multiplexer 126 is coupled to the first storage unit controllers 122 and the buffer 124. Each of the data access controllers 400 is utilized to couple to one of a plurality of second storage unit controllers 142 within a second controller 500, whereby the plurality of data access controllers 400 can couple with the same number of the plurality of second storage unit controllers 142. Moreover, the host 160 is capable of parallel accessing a plurality of storage units 110 through at least one of first storage unit controller 142 and the corresponding data access controller 400, wherein the number of the at least one of first storage unit controller 142 is less than the number of the storage units 110.

It is worth mentioning that the plurality of second storage unit controllers 142 are disposed in one second controller 500, so that the host 160 accesses the storage units 110 through the second controller 500 and the data access controllers 400. Actually, the second controller 500 is the same with the second controller 140 of the above-mentioned third embodiment, which further has the processor and the data interface controller, so no further detail will be provided herein.

It is worth mentioning that the storage unit 110 has a read/write unit, and the capacity of the buffer in the data access controllers 400 is equal to an integer multiple of that of the read/write unit. The buffer 124 is utilized to temporarily store the read/write data from the storage units 110, so as to increase the parallelism of data processing of the data access controllers 400.

Specifically, the storage units 110 are a plurality of eMMC devices, and each of the first storage unit controllers 122 is the eMMC host controller. In the embodiment, the transmission thereof is explained as the standard for the eMMC, but it is not limited to this. For example, the eMMC specification can be replaced by the standard for an embedded Secure Digital (eSD) card or for an embedded Compact Flash (eCF) card, as long as the interfaces used between the first storage unit controllers 122 and the storage units 110 are the same. It should be noted that the second storage unit controller 142 of the embodiment also can be the standard eMMC host controller.

What follows is the operation with respect to the data access controller 400 of the data embodiment. In the embodiment, the second storage unit controllers 142 can send the vendor commands to the corresponding data access controllers 400. Based on the control of the vendor commands, the one-to-many objective is achieved.

In another embodiment, each of the data access controllers 400 further includes the memory unit 128, at which the lookup table (LUT) is stored. Specifically, the storage units 110 are simulated as the block device, such as the hard disk. Before accessing the storage units 110, the lookup table includes the information of logical-physical address mapping, which is utilized to record the relationship of logical block addresses (LBA) converting into physical block addresses (PBA). The logical block addresses are the block addresses which a file system accesses the data; the physical block addresses are the block addresses to which the logical block addresses actually correspond in the storage units 110.

In summary, the data access controllers 400 of the embodiment can be utilized as the media for the conventional eMMC host controllers coupling to the multiple storage units, thereby solving the problem of the one-to-one connection.

While the embodiments of the present disclosure have been illustrated and described in detail, various modifications and alterations can be made by persons skilled in this art. The embodiment of the present disclosure is therefore described in an illustrative but not restrictive sense.

What is claimed is:

1. A data access system, comprising:
a plurality of storage units;
a plurality of first controllers utilized to parallel access the plurality of storage units, each of the first controllers comprising:
a plurality of first storage unit controllers coupled one-to-one with the storage units;
a buffer; and
a multiplexer coupled to the plurality of first storage unit controllers and the buffer;
a second controller coupled to the plurality of first controllers, the second controller comprising:
a plurality of second storage unit controllers coupled one-to-one with the first controllers; and
a host coupled to the second controller;
wherein the host accesses the plurality of storage units through the second controller and the plurality of first controllers.

2. The data access system of claim 1, wherein each of the plurality of second storage unit controllers accesses at least two storage units of the plurality of storage units through a corresponding controller of the plurality of first controllers.

3. The data access system of claim 2, wherein the corresponding controller accesses the at least two storage units in an interleaved manner.

4. The data access system of claim 1, wherein each of the plurality of storage units includes a read/write unit, wherein a capacity of the buffer is equal to an integer multiple of that of the read/write unit.

5. The data access system of claim 1, wherein the plurality of storage units are a plurality of embedded multi-media card (eMMC) devices.

6. The data access system of claim 5, wherein each of the plurality of second storage unit controllers is an eMMC host controller.

7. The data access system of claim 2, wherein the second controller further comprises a storage unit selector for selecting one of the at least two storage units of the plurality of storage units to be accessed.

8. The data access system of claim 1, wherein each of the plurality of first controllers further comprises a memory unit, at which a lookup table is stored.

9. The data access system of claim 1, wherein the second controller further comprises:
a processor coupled to the plurality of second storage unit controllers; and
a data interface controller coupled between the processor and the host.

10. The data access system of claim 9, wherein the data interface controller is a serial data interface controller, which is one of SATA, USB, eSATA, PCI-e, and IEEE1394 controller.

11. A data access system, comprising:
a plurality of storage units;
a first controller utilized to parallel access the plurality of storage units, the first controller comprising:
a plurality of first storage unit controllers coupled one-to-one with the plurality of storage units;
a buffer; and
a multiplexer coupled to the plurality of first storage unit controllers and the buffer;
a second controller coupled to the first controller, the second controller comprising:
a second storage unit controller coupled to the first controller; and
a host coupled to the second controller;
wherein the host accesses the plurality of storage units through the second controller and the first controller.

12. The data access system of claim 11, wherein the storage units are a plurality of eMMC devices.

13. The data access system of claim 12, wherein the second storage unit controller is an eMMC host controller.

14. The data access system of claim 11, wherein the second controller further comprises a storage unit selector for selecting one of the storage units to be accessed.

15. The data access system of claim 11, wherein the first controller further comprises a memory unit, at which a lookup table is stored.

16. A data access device, comprising:
a plurality of storage units;
a first controller utilized to parallel access the plurality of storage units, the first controller comprising:
a plurality of first storage unit controllers coupled one-to-one with plurality of the storage units;
a buffer; and
a multiplexer coupled to the plurality of first storage unit controllers and the buffer; and
a second controller coupled to the first controller, the second controller comprising:
a second storage unit controller coupled to the first controller;
a processor coupled to the second storage unit controller; and
a data interface controller coupled to the processor.

17. The data access device of claim 16, wherein each of the storage units is an embedded memory.

18. The data access device of claim 17, wherein the embedded memory is an eMMC.

19. The data access device of claim 18, wherein the second storage unit controller is an eMMC host controller.

20. The data access device of claim 16, wherein the second controller further comprises a storage unit selector for selecting one of the plurality of storage units to be accessed.

21. The data access device of claim 16, wherein the first controller further comprises a memory unit, at which a lookup table is stored.

22. A data access controller for parallel accessing a plurality of storage units and coupling to another controller, the data access controller comprising:
a plurality of first storage unit controllers coupled one-to-one with the plurality of storage units;
a buffer; and
a multiplexer coupled to the plurality of first storage unit controllers and the buffer.

23. The data access controller of claim 22, wherein each of the plurality of storage units includes a read/write unit, and wherein a capacity of the buffer is equal to an integer multiple of that of the read/write unit.

24. The data access controller of claim 22, wherein each of the plurality of first storage unit controllers is an eMMC host controller.

25. The data access controller of claim 22, further comprising a memory unit, at which a lookup table is stored.

26. The data access controller of claim 22, wherein the another controller has at least one second storage unit controller for coupling to the multiplexer, and a number of the at least one second storage unit is less than that of the plurality of storage units.
